(19) United States
(12) Patent Application Publication
(10) Pub. No.: US 2012/0180946 A1
(43) Pub. Date: Jul. 19, 2012

(54) METHOD FOR ATTACHING AN ELECTRONIC ASSEMBLY TO A BOTTOM OVERLAY IN THE MANUFACTURE OF AN ELECTRONIC DEVICE

(76) Inventor: ROBERT SINGLETON, Lakeland, FL (US)

(21) Appl. No.: 13/351,835

(22) Filed: Jan. 17, 2012

Related U.S. Application Data
(60) Provisional application No. 61/433,724, filed on Jan. 18, 2011.

(51) Int. Cl. B29C 45/14; B29C 65/14

(52) U.S. Cl. 156/245; 156/275.7

(57) ABSTRACT

A method for adhering an electronic assembly to a bottom cover sheet in the manufacture of an electronic device is presented. According to the method, the electronic assembly is attached to the bottom overlay using a modified ultra violet (“UV”) cured adhesive.

### BACKGROUND

The present invention relates generally to the field of devices containing electronic assemblies.

Generally, these devices may be used as credit cards, bankcards, ID cards, telephone cards, security cards, smart cards, lifestyle cards, tags or similar devices. These devices are generally constructed by assembling several layers of plastic sheets in a sandwich array. Further, these devices may contain electronic assemblies that enable the device to perform a number of functions.

European Patent 0 350 179 discloses a smart card wherein electronic circuitry is encapsulated in a layer of plastic material that is introduced between the card's two surface layers. The method disclosed further comprises abutting a high tensile strength holding member against a side of a mold, locating the smart card's electronic components with respect to that side and then injecting a reaction moldable polymeric material into the mold such that it encapsulates the electronic components.

European Patent Application 95400365.3 teaches a method for making contact-less smart cards. The method employs a rigid frame to position and fix an electronic module in a void space between an upper thermoplastic sheet and a lower thermoplastic sheet. After the frame is mechanically affixed to the lower thermoplastic sheet, the void space is filled with a polymerizable resin material.

U.S. Pat. No. 5,399,847 teaches a credit card that is comprised of three layers, namely, a first outer layer, a second outer layer and an intermediate layer. The intermediate layer is formed by injection of a thermoplastic binding material that encases the smart card's electronic elements (e.g., an 1C chip and an antenna) in the intermediate layer material. The binding material is preferably made up of a blend of copolyamides or a glue having two or more chemically reactive components that harden upon contact with air. The outer layers of this smart card can be made up of various polymeric materials, such as polyvinyl chloride or polyurethane.

U.S. Pat. No. 5,417,905 teaches a method for manufacturing plastic credit cards wherein a mold tool comprised of two shells is closed to define a cavity for producing such cards. A label or image support is placed in each mold shell. The mold shells are then brought together and a thermoplastic material is injected into the mold to form the card. The inflowing plastic forces the labels or image supports against the respective mold faces.

U.S. Pat. No. 5,510,074 teaches a method of manufacturing smart cards having a card body with substantially parallel major sides, a support member with a graphic element on at least one side, and an electronic module comprising a contact array that is fixed to a chip. The manufacturing method generally comprises the steps of: (1) placing the support member in a mold that defines the volume and shape of the card; (2) holding the support member against a first main wall of the mold; (3) injecting a thermoplastic material into the volume defined by the hollow space hi order to fill that portion of the volume that is not occupied by the support member; and (4) inserting an electronic module at an appropriate position in the thermoplastic material before the injected material has the opportunity to completely solidify.

U.S. Pat. No. 4,339,407 discloses an electronic circuit encapsulation device in the form of a carrier having walls that have a specific arrangement of lands, grooves and bosses in combination with specific orifices. The mold's wall sections hold a circuit assembly in a given alignment. The walls of the carrier are made of a slightly flexible material in order to facilitate insertion of the smart card's electronic circuitry. The carrier is capable of being inserted into an outer mold. This causes the carrier walls to move toward one another in order to hold the components securely in alignment during the injection of the thermoplastic material. The outside of the walls of the carrier has projections that serve to mate with detents on the walls of the mold in order to locate and fix the carrier within the mold. The mold also has holes to permit the escape of trapped gases.

U.S. Pat. No. 5,350,553 teaches a method of producing a decorative pattern on, and placing an electronic circuit in, a plastic card in an injection molding machine. The method comprises the steps of: (a) introducing and positioning a film (e.g., a film bearing a decorative pattern) over an open mold cavity in the injection molding machine; (b) closing the mold cavity so that the film is fixed and clamped in position therein; (c) inserting an electronic circuit chip through an aperture in the mold into the mold cavity hi order to position the chip in the cavity; (d) injecting a thermoplastic support composition into the mold cavity to form a unified card; (e) removing any excess material; (f) opening the mold cavity; and (g) removing the card.

U.S. Pat. No. 4,961,893 teaches a smart card whose main feature is a support element that supports an integrated circuit chip. The support element is used for positioning-the chip inside a mold cavity. The card body is formed by injecting a plastic material into the cavity so that the chip is entirely embedded in the plastic material. In some embodiments, the edge regions of the support are clamped between the load bearing surfaces of the respective molds. The support element may be a film that is peeled off the finished card or it may be a sheet that remains as an integral part of the card. If the support element is a peel-off film, then any graphics elements contained therein are transferred and remain visible on the card. If the support element remains as an integral part of the card, then such graphics elements are formed on a face thereof and, hence, are visible to the card user.

U.S. Pat. No. 5,498,388 teaches a smart card device that includes a card board having a through-opening. A semiconductor module is mounted onto this opening. A resin is injected into the opening so that a resin molding is formed under such condition that only an electrode terminal face for external connection of said semiconductor module is exposed. The card is completed by mounting a card board having a through-opening onto a lower mold of two opposing molding dies, mounting a semiconductor module onto the opening of said card board, tightening an upper die that has a gate leading onto a lower die and injecting a resin into the opening via the gate.

U.S. Pat. No. 5,423,705 teaches a disc having a disc body made of a thermoplastic injection molded material and a laminate layer that is integrally joined to a disc body. The laminate layer includes an outer clear lamina and an inner white and opaque lamina. An imaging material is sandwiched between these lamina.

U.S. Pat. No. 6,025,054 discloses a method for constructing a smart card using low shrinkage glue to hold the electronic devices in place during the devices immersion in thermosetting material that becomes the core layer of the smart card.

Generally, all of the above methods involve using specialized processes, pedestals, anchors or other devices for adhering the electronic assemblies to one of the printed overlays.

### SUMMARY

According to one embodiment, a method is disclosed that includes the steps of using a unique modified UV curable adhesive to affix to the top surface of a bottom overlay to a circuit board with an electronic assembly, loading the electronic assembly adhered to the bottom overlay into an injection molding apparatus, loading a top overlay positioned above a top surface of the electronic assembly into the injection molding apparatus, closing the molding apparatus, and injecting a thermosetting polymeric material between the top and bottom overlays.

It is to be understood that the foregoing general description and the following detailed descriptions are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 shows a schematic view of the top side of an overlay that has had the circuit outline screen printed with unique modified UV curable adhesive.

FIG. 2 shows a schematic view of the top side of an overlay with a circuit placed on top of the screen printed unique modified UV curable adhesive.

FIG. 3 shows a cross sectional view of an electronic device consisting of a bottom overlay, a layer of unique modified UV curable adhesive screen printed to the top side of the bottom overlay, an electronic assembly attached to the top side of the printed unique modified UV curable adhesive, and a layer of injected thermosetting material between the bottom side of a top overlay and the top side of the electronic assembly.

FIG. 4 is a flowchart illustrating a process for forming an electronic device.

### DETAILED DESCRIPTION

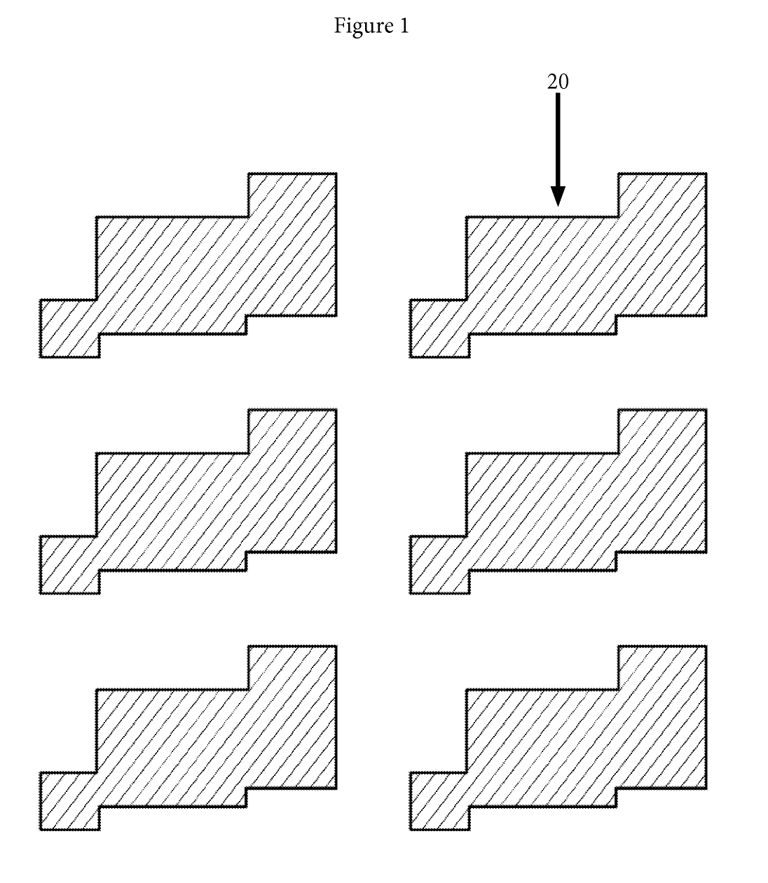

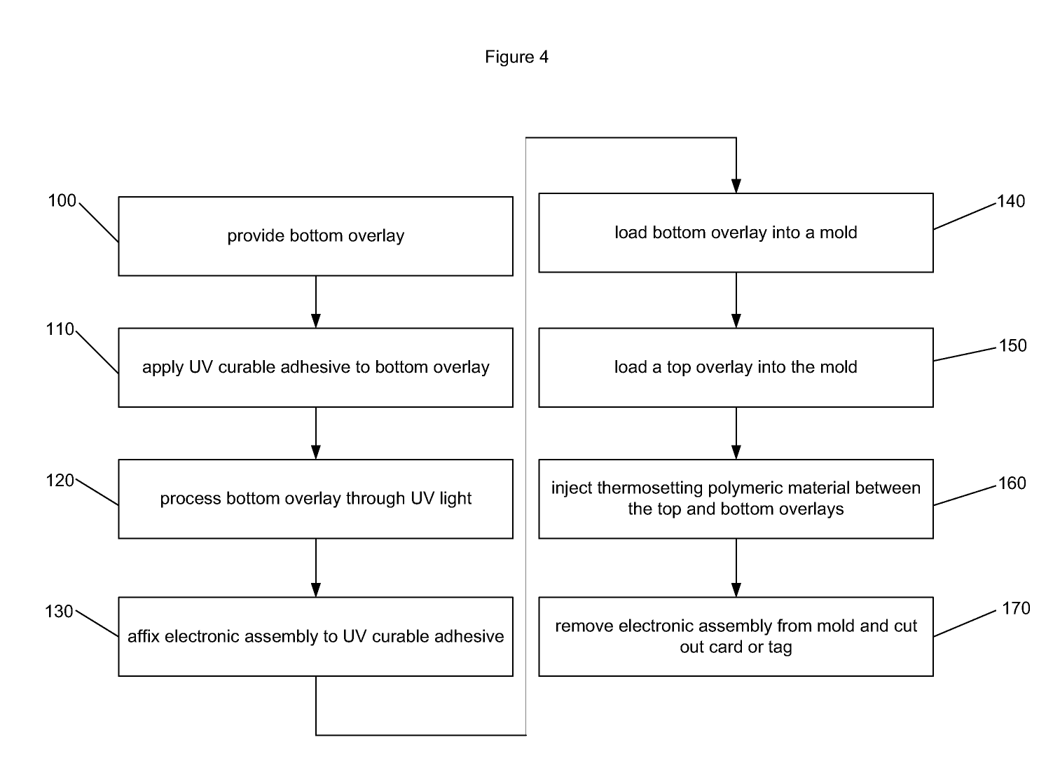

FIG. 1 shows a schematic view of the top side of a bottom overlay 10 for an electronic device 60. As shown in FIG. 1 and in steps 100 and 110 of FIG. 4, a unique modified UV curable adhesive 20 is affixed to the top side of a bottom overlay 10 exhibiting an area just slightly larger than the perimeter measurement of an electronic assembly. The UV curable adhesive 20 is configured to be applied to a surface in controlled amounts. The UV curable adhesive 20 can be affixed via screen printing, spray or any other known application for applying adhesive 20 to a surface.

Next, in step 120, the bottom overlay 10, having the applied unique modified UV curable adhesive 20, is processed through an ultra violet light system to activate the unique modified UV curable adhesive 20. Upon application of UV light, the UV curable adhesive 20 becomes tacky or sticky.

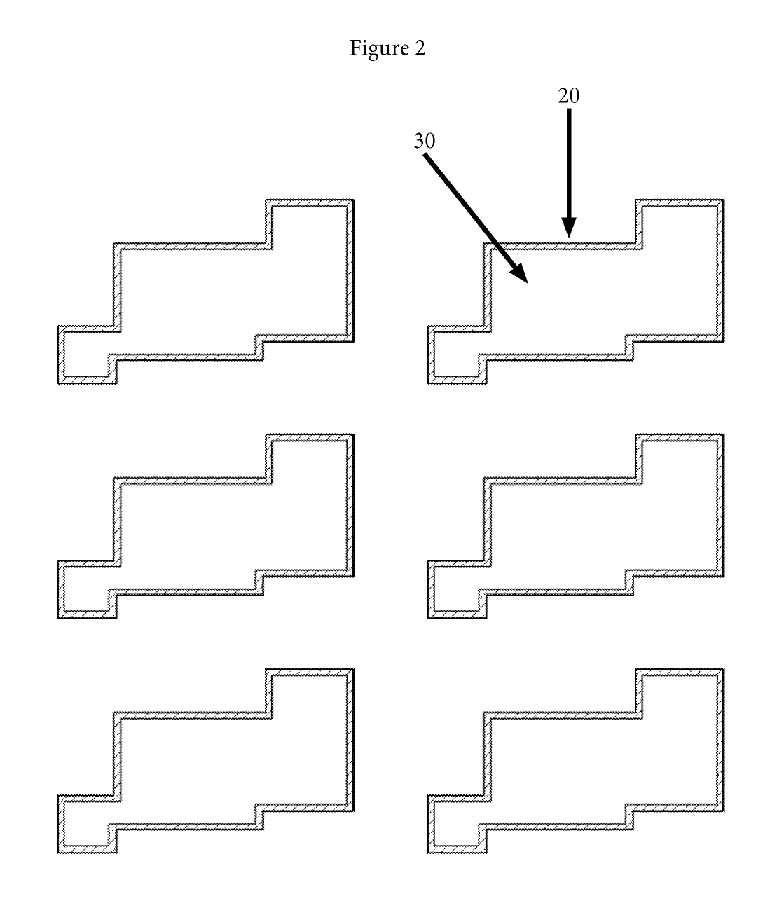

As shown in FIG. 2, in step 130 an electronic assembly 30 is placed on the top side of the screen printed unique modified UV curable adhesive 20. The electronic assembly 30 may include one or more circuit components, including but not limited to a printed circuit board, a button, a switch, a battery, an LCD or other electronic components that may be required or useful in an electronic device 60. Because the UV curable adhesive 20 has been exposed to UV light and is sticky or tacky, the electronic assembly 30 can be easily affixed to the UV curable adhesive 20. The UV curable adhesive 20 then cures for a period of time to create a permanent bond. Preferably, it takes approximately twenty-four hours for the UV curable adhesive 20 to cure. The fact that the UV curable adhesive 20 does not cure upon immediate exposure to UV light makes it extremely flexible and ideal for the electronic device manufacturing process.

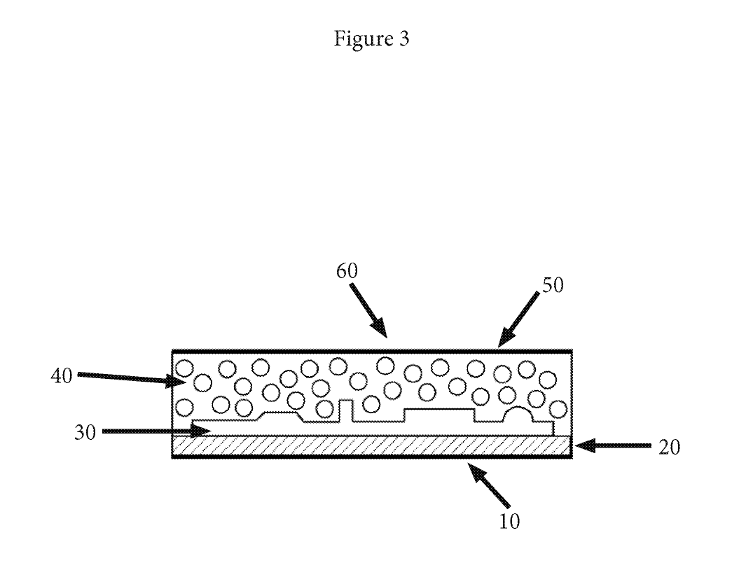

Then, in step 140 the bottom overlay 10 with the electronic assembly 30 attached is loaded into a mold with the electronic assembly 30 positioned on top. In step 150, a top overlay 50 that has a top surface and a bottom surface is loaded above the electronic assembly 30 that is affixed to the top surface of the bottom overlay 10. Next, in step 160, the mold is closed and a thermosetting polymeric material 40 is injected between the top overlay 50 and bottom overlay 10. In step 170, the mold is opened and the injected top overlay 50 and bottom overlay 10 containing the electronic assembly 30 is removed from the mold. Finally, the electronic device 60 is cut out based size specifications, etc. FIG. 3 shows a completed electronic device 60, having a bottom overlay 10, a unique modified UV curable adhesive 20 affixed on the top side of the bottom overlay 10, an electronic assembly 30 adhered to the top side of the screen printed unique modified UV curable adhesive 20, and a layer of thermoset material 40 positioned between the top of the electronic assembly 30 and the bottom side of the top overlay 50.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present intention. The scope of the present invention is to be defined as set forth in the following claims.

What is claimed is:

1. A method for attaching an electronic assembly to a bottom overlay in the manufacture of an electronic device, comprising:
providing a bottom overlay that has a top surface and a bottom surface;
applying a unique modified UV curable adhesive directly to the top of the bottom overlay;
processing the bottom overlay with the applied unique modified UV curable adhesive through an ultra violet light system to activate the unique modified UV curable adhesive; and
affixing the electronic assembly directly to the top of the activated unique modified UV curable adhesive.

2. A method for manufacturing an electronic device, comprising:
providing a bottom overlay that has a top surface and a bottom surface;
applying a unique modified UV curable adhesive directly to the top of the bottom overlay;
processing the bottom overlay with the applied unique modified UV curable adhesive through an ultra violet light system to activate the unique modified UV curable adhesive;
affixing the electronic assembly directly to the top of the activated unique modified UV curable adhesive;
loading the bottom overlay with the electronic assembly attached into a mold with the electronic assembly positioned on top;
loading a top overlay that has a top surface and a bottom surface above the electronic assembly affixed to the top surface of the bottom overlay;
closing the mold and injecting a thermosetting polymeric material between the top and bottom overlays;
opening the mold and removing the injected top and bottom overlays containing the electron assembly from the mold; and
cutting out the electronic device.
